(19) United States
(12) Patent Application Publication
(10) Pub. No.: US 2013/0222694 A1
(43) Pub. Date: Aug. 29, 2013

(54) SYSTEM AND METHOD FOR PROVIDING AUGMENTED AUDIO SERVICE

(71) Applicants: Young Ho JEONG, Daejeon-si (KR); Jin Woo HONG, Daejeon-si (KR)

(72) Inventors: Young Ho JEONG, Daejeon-si (KR); Jin Woo HONG, Daejeon-si (KR)

(73) Assignee: Electronics and Telecommunications Research Institute, Daejeon (KR)

(21) Appl. No.: 13/563,059

(22) Filed: Jul. 31, 2012

(30) Foreign Application Priority Data
Feb. 27, 2012 (KR) 10-2012-0019472

(51) Int. Cl. H04N 5/60

(52) U.S. Cl. 348/485; 348/E05.125

(57) ABSTRACT

The server of a system for providing augmented audio service according to the present invention includes a video data server for providing video data to a display device and an audio data server for providing a plurality of audio output devices with augmented audio data corresponding to video outputted based on the video data from the display device, wherein the plurality of audio output devices output different frequencies for augmenting audio of the video based on the augmented audio data.

### CROSS-REFERENCE TO RELATED APPLICATIONS

This application claims the benefit of priority of Korean Patent Application No. 10-2012-0019472 filed on Feb. 27, 2012, all of which is incorporated by reference in its entirety herein.

### BACKGROUND OF THE INVENTION

1. Field of the Invention

The present invention relates to a system and method for providing augmented audio service and, more particularly, to a system and method for providing augmented audio service which augment audio outputted from a display device.

2. Discussion of the Related Art

Television (TV), that is, a common display device, is evolving into smart TV in order to overcome the limitations of Internet protocol TV and connected TV that provide only manual viewing for content.

Smart TV provides various bi-directional services and has an Internet browsing function, thereby converging broadcasting and communication. Smart TV positively accommodates On The Top (OTT) service in order to meet various demands of viewers. App stores and media markets are providing various services and various pieces of content.

In smart TV, the consumption of video content having high picture quality forms the main stream, and the importance of audio service related to video content is being highlighted. Accordingly, researches and development into audio service continue to be carried out. As one of methods for audio service, there is disclosed Korean Patent Laid-Open Publication No. 10-2005-0069344 entitled ‘A TV with Home Theater Speaker System’.

In the disclosed patent, a main speaker and one or more sub-speakers are installed in the TV. Accordingly, a client may selectively listen to a speaker system of a 2.1 channel or a 5.1 channel by controlling the speakers of the TV. However, the disclosed patent is problematic in that the production cost is increased because additional speakers are installed. For this reason, there is a need for technology capable of augmenting the audio of TV without installing an additional speaker.

### PRIOR ART DOCUMENT

### Patent Document

Korean Patent Laid-Open Publication No. 10-2005-0069344 entitled ‘A TV with Home Theater Speaker System’.

### SUMMARY OF THE INVENTION

An object of the present invention is to provide a system and method for providing augmented audio service which are capable of augmenting the audio of a display device by using audio output devices owned by a viewer without installing an additional speaker.

In an aspect, the server of a system for providing augmented audio service includes a video data server for providing video data to a display device and an audio data server for providing a plurality of audio output devices with augmented audio data corresponding to video outputted based on the video data from the display device, wherein the plurality of audio output devices output different frequencies for augmenting the audio of the video based on the augmented audio data.

The audio data server may receive information about the plurality of audio output devices, operated in conjunction with the display device and searched for by the display device, from the display device.

In another aspect, a method of transmitting augmented audio service includes providing video data to a display device and providing augmented audio data, corresponding to video outputted from the display device based on the video data, to a plurality of audio output devices.

The method may further include receiving and storing information about the plurality of audio output devices through the display device operated in conjunction with the plurality of audio output devices, before providing the augmented audio data to the plurality of audio output devices.

The plurality of audio output devices may augment the audio of the video by outputting different frequencies based on the augmented audio data.

In yet another aspect, an augmented audio output system includes a plurality of audio output devices for receiving augmented audio data from an audio data server, wherein the plurality of audio output devices augments the audio of video, outputted from a display device operated in conjunction with an audio data server, by outputting different frequencies based on the augmented audio data.

The plurality of audio output devices may synchronize the augmented audio data with the video and output the synchronized augmented audio data.

The plurality of audio output devices may provide their own information to the audio data server through the display device while operating in conjunction with the display device.

In further yet another aspect, a method of outputting augmented audio includes a plurality of audio output devices receiving augmented audio data from an audio data server and the plurality of audio output devices augmenting the audio of video, outputted from a display device operated in conjunction with the audio data server, by outputting different frequencies based on the augmented audio data.

The method may further include the plurality of audio output devices synchronizing the augmented audio data with the video, before augmenting the audio of the video.

The method may further include the plurality of audio output devices providing their own information to the audio data server through the display device, before receiving the augmented audio data.

In still yet another aspect, the display device of a system for providing augmented audio service includes an output unit for outputting video and a control unit for sending information about a plurality of audio output devices for augmenting the audio of the video to an audio data server operated in conjunction with the plurality of audio output devices, wherein the plurality of audio output devices receives augmented audio data from the audio data server and outputs the received augmented audio data as different frequencies based on the information.

The control unit may receive the information from the plurality of audio output devices.

In still yet another aspect, an augmented audio service method includes outputting video and sending information about a plurality of audio output devices for outputting augmented audio for augmenting the audio of the video to an audio data server operated in conjunction with the plurality of audio output devices.

The augmented audio service method may further include receiving the information from the plurality of audio output devices, before sending the information about the plurality of audio output devices.

The augmented audio service method may further include checking whether the audio data server is capable of providing the augmented audio, after outputting the video.

The plurality of audio output devices may receive augmented audio data from the audio data server and output the received augmented audio data as different frequencies based on the information.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a construction showing a system for providing augmented audio service according to an embodiment of the present invention;

FIG. 2 is a block diagram showing a method of providing augmented audio service according to an embodiment of the present invention; and

FIG. 3 is a block diagram showing a procedure of providing augmented audio service according to an embodiment of the present invention.

### DETAILED DESCRIPTION OF THE EMBODIMENTS

Hereinafter, some embodiments of the present invention will be described in detail with reference to the accompanying drawings. However, the present invention is not limited to the disclosed embodiments, but may be implemented in various forms. The shapes of elements in the drawings may be enlarged in order to highlight a clearer description, and the same reference numbers are used throughout the drawings to refer to the same parts.

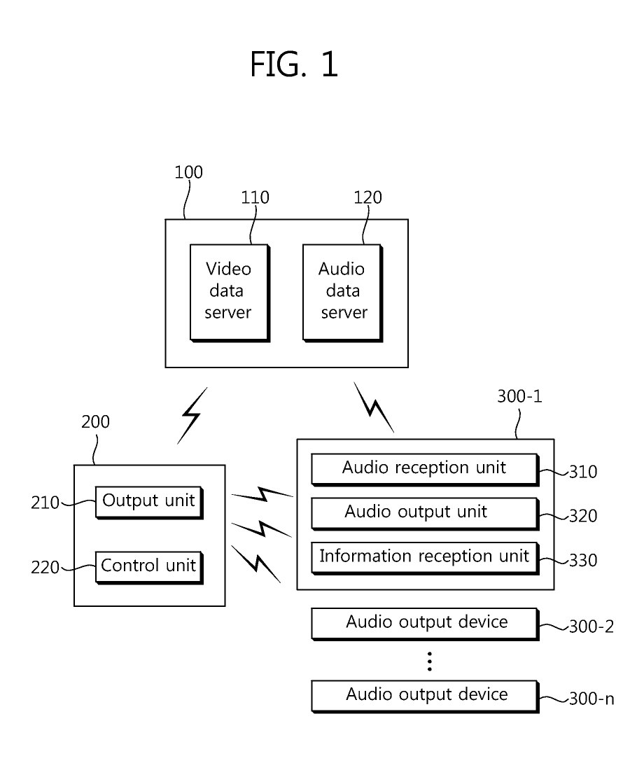

FIG. 1 is a construction showing a system for providing augmented audio service according to an embodiment of the present invention.

As shown in FIG. 1, the system for providing augmented audio service according to the embodiment of the present invention may include a server 100, a display device 200 for receiving video from the server 100, and a plurality of audio output devices 300-1, . . . , 300-n (n is a natural number of 2 or more) for receiving augmented audio from the server 100. The server 100, the display device 200, and the plurality of audio output devices 300-1, . . . , 300-n may be operated in conjunction each other over a network. The network may be a wired network or a wireless network.

The server 100 and the display device 200 may be coupled according to a server-client method based on unicast. For example, a client (i.e., a service user) may exchange pieces of necessary information with the server 100 through the display device 200. The server 100 may include a video data server 110 for managing video data and an audio data server 120 for managing augmented audio data for augmenting the audio of the video data. The video data server 110 may store and manage various pieces of video content including Video On Demand (VOD) service having high quality. Furthermore, the video data server 110 may provide video data to the display device 200 in response to a request from a client which is transmitted by the display device 200.

The audio data server 120 may store and manage augmented audio data corresponding to video data. The audio data server 120 may provide the audio output devices 300-1, . . . , 300-n with at least one of multi-channel audio service, multi-audio service, and multi-layered audio service having high quality in response to a request from a client which is transmitted by the display device 200.

The display device 200 may receive and output wired and wireless network services, such as terrestrial wave programs and movie broadcasting, and may output video including contents desired by a client on the basis of video data provided by the video data server 110. For example, the display device 200 may include an output unit 210 for outputting video and a control unit 220 for searching for information about the audio output devices 300-1, . . . , 300-n from which augmented audio corresponding to video will be supplied and providing the retrieved information to the audio data server 120.

Various display devices, including TV, may be used as the display device 200. A settop box (not shown) may be included in the display device, if necessary.

The audio output devices 300-1, . . . , 300-n output different frequencies on the basis of augmented audio data in order to augment the audio of video outputted from the display device 200. For example, the audio output device 300-1 may include an audio reception unit 310 for receiving augmented audio data transmitted by the audio data server 120, an audio output unit 320 for synchronizing augmented audio data and video and outputting the synchronized audio and video, and an information reception unit 330 for sending information about the audio output devices 300-1, . . . , 300-n to the display device 200.

Furthermore, the audio output devices 300-1, . . . , 300-n may directly receive augmented audio data from the audio data server 120 or may receive augmented audio data from the audio data server 120 via the display device 200. The audio output devices 300-1, . . . , 300-n may output augmented audio in real time or may download augmented audio and output the downloaded audio, if necessary.

Meanwhile, mobile terminals or bone-construction devices may be used as the audio output devices 300-1, . . . , 300-n.

If mobile terminals are provided as the audio output devices 300-1, . . . , 300-n, a client may receive high-quality augmented audio service by a combination of a plurality of mobile terminals. In general, a client may easily implement high-quality augmented audio on the basis of a plurality of mobile terminals because the mobile terminal has almost the same audio output performance as the display device 200.

Meanwhile if the bone-construction devices are provided as the audio output devices 300-1, . . . , 300-n, several clients may individually listen to augmented audio service. Several clients may be provided with multi-audio service based on multiple languages. For example, clients may have respective bone-construction devices attached thereto. The clients may listen to augmented audio of desired languages received from the audio data server 120 while viewing common video.

In terms of the bone-construction device, clients may be free from noise of audio heard by other clients placed around. Furthermore, clients may listen to sound generated around at the same time.

The bone-construction device is configured to convert sound into vibration and to stimulate the auditory nerve through a bone. The bone-construction device may include a bone-construction vibrator, an audio processing module, and a wireless module.

A method of providing augmented audio service according to the present invention is described in detail below with reference to the accompanying drawings. Although a service method is sequentially described in order to help understanding of augmented audio service according to the present invention, the service method may be changed depending on a use environment and by a client.

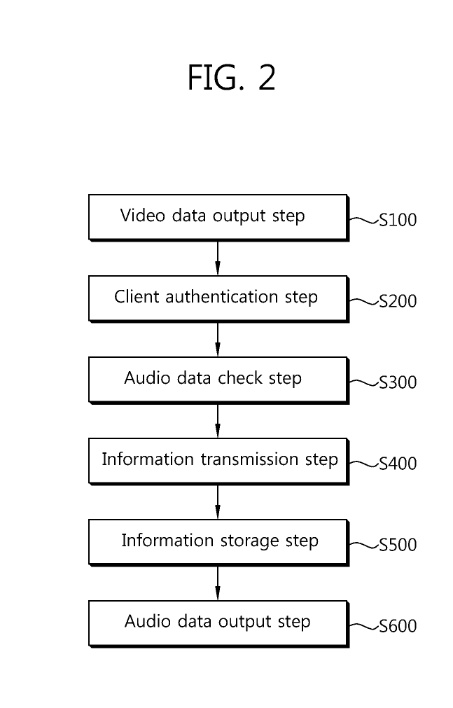

FIG. 2 is a block diagram showing a method of providing augmented audio service according to an embodiment of the present invention.

As shown in FIG. 2, the method of providing augmented audio service (hereinafter simply referred to as the ‘service method’) according to the embodiment of the present invention may include a video data output step S100, a client authentication step S200, an audio data check step S300, an information transmission step S400, an information storage step S500, and an audio data output step S600.

The display device 200 outputs video based on video data transmitted by the video data server 110 at step S100. For example, a client may request desired video from the video data server 110 through the display device 200, and the display device 200 may output the desired video received from the video data server 110.

Next, the audio data server 120 checks the identity of the client in order to provide augmented audio service to the client at step S200. For example, the identity of the client may be authenticated through the display device 200 connected to the audio data server 120 over a network. Accordingly, the service method may improve reliability of augmented audio service and switches to pay service.

Furthermore, in the client authentication step S200, a method of performing authentication is not limited to the method using the display device 200, and a variety of methods, such as a telephone authentication method and a method using a password based on previously provided information, may be used.

Next, the client may check whether augmented audio service for augmenting the audio of video being viewed may be provided or not at step S300. For example, the client may access the audio data server 120 through the display device 200, check whether there is augmented audio data or not, and select the supply of augmented audio service.

If it is checked that the augmented audio service is possible, the display device 200 may search for information about the audio output devices 300-1, . . . , 300-n placed around and transmit the retrieved information to the audio data server 120 at step S400. Here, the client may manually search for the information about the audio output devices 300-1, . . . , 300-n and send the retrieved information to the audio data server 120. As an alternative, the display device 200 and the audio data server 120 may check the information about the audio output devices 300-1, . . . , 300-n by utilizing a network.

Next, the audio data server 120 may store the information about the audio output devices 300-1, . . . , 300-n at step S500. Accordingly, when the client uses augmented audio service again, the client may be provided with the augmented audio service based on the stored information even though the client does not experience the information transmission step S400.

The audio output devices 300-1, . . . , 300-n receive augmented audio data from the audio data server 120. Next, the audio output devices 300-1, . . . , 300-n may output the augmented audio data so that the audio data is synchronized with video provided by the display device 200 at step S600. Here, the audio output devices 300-1, . . . , 300-n may receive the augmented audio data from the audio data server 120 in real time over a network or may previously download the augmented audio data from the audio data server 120 and output the audio data.

A procedure of providing augmented audio service according to the present invention is described in detail below with reference to the accompanying drawings.

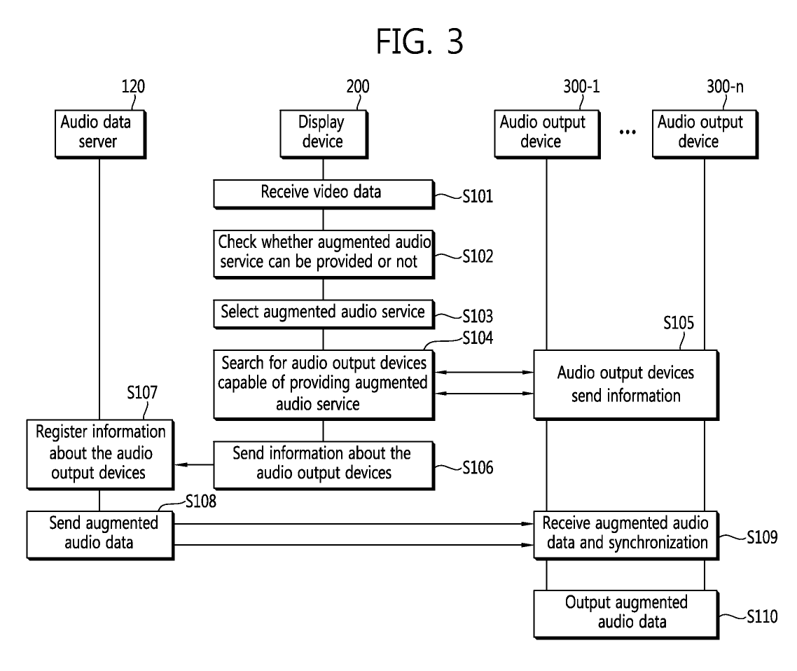

FIG. 3 is a block diagram showing the procedure of providing augmented audio service according to an embodiment of the present invention.

As shown in FIG. 3, in the procedure of providing augmented audio service according to the embodiment of the present invention, the audio data server 120, the display device 200, and the plurality of audio output devices 300-1, . . . , 300-n may be connected over a network.

A client may receive video through the display device 200 and view the received video at step S101. If the client wants augmented audio service for the video being viewed, the client may check whether the augmented audio service can be provided or not through the display device 200 at step S102.

If, as a result of the check, the augmented audio service can be provided, the client may select the augmented audio service at step S103. When the client selects the augmented audio service, the display device 200 may search for the audio output devices 300-1, . . . , 300-n placed near the display device 200, which may provide the augmented audio service at step S104.

At this time, the information reception units 330 of the audio output devices 300-1, . . . , 300-n provide information about the audio output devices 300-1, . . . , 300-n to the control unit 220 of the display device 200 at step S105. The display device 200 receives the information about the audio output devices 300-1, . . . , 300-n and send the received information to the audio data server 120 at step S106.

The audio data server 120 registers the information received from the display device 200 at step S107. After the information is registered, the audio data server 120 sends the augmented audio data, requested by the client, to the audio reception units 310 of the audio output devices 300-1, . . . , 300-n at step S108.

At this time, the audio output devices 300-1, . . . , 300-n receive the augmented audio data from the audio data server 120. Furthermore, the audio output devices 300-1, . . . , 300-n synchronize the augmented audio data with video of the display device 200 at step S109. Next, after the synchronization is completed, the audio output devices 300-1, . . . , 300-n may output augmented audios having different frequencies based on the augmented audio data so that the audio of the video is augmented at step S110.

As described above, the system and method for providing augmented audio service according to the present invention may implement high-quality augmented audio by using augmented audio service on the basis of the audio output devices 300-1, . . . , 300-n owned by a client even without installing an additional device for obtaining augmented audio.

Furthermore, in the system and method for providing augmented audio service, a client may implement a desired multi-audio system by controlling the positions of a plurality of audio output devices 300-1, . . . , 300-n.

Furthermore, the system and method for providing augmented audio service according to the present invention is advantageous in that a sense of viewing satisfaction due to high-quality audio service and the degree of viewing immersion can be improved.

Technical objects of the present invention are not limited to the above-described object and other technical objects that have not been described above will become evident to those skilled in the art from the following description.

The embodiments of the present invention described above and shown in the drawings should not be construed as limiting the technical spirit of the present invention. The scope of the present invention is restricted by only the claims, and a person having ordinary skill in the art to which the present invention pertains may improve and modify the technical spirit of the present invention in various forms. Accordingly, the modifications and modifications will fall within the scope of the present invention as long as they are evident to those skilled in the art.

What is claimed is:

1. A server of a system for providing augmented audio service, the server comprising:
a video data server for providing video data to a display device; and
an audio data server for providing a plurality of audio output devices with augmented audio data corresponding to video outputted based on the video data from the display device,
wherein the plurality of audio output devices output different frequencies for augmenting audio of the video based on the augmented audio data.

2. The server as claimed in claim 1, wherein the audio data server receives information about the plurality of audio output devices, operated in conjunction with the display device and searched for by the display device, from the display device.

3. A method of transmitting augmented audio service, comprising:
providing video data to a display device; and
providing augmented audio data, corresponding to video outputted from the display device based on the video data, to a plurality of audio output devices.

4. The method as claimed in claim 3, further comprising receiving and storing information about the plurality of audio output devices through the display device operated in conjunction with the plurality of audio output devices, before providing the augmented audio data to the plurality of audio output devices.

5. The method as claimed in claim 3, wherein the plurality of audio output devices augments audio of the video by outputting different frequencies based on the augmented audio data.

6. An augmented audio output system, comprising:
a plurality of audio output devices for receiving augmented audio data from an audio data server,
wherein the plurality of audio output devices augments audio of video, outputted from a display device operated in conjunction with an audio data server, by outputting different frequencies based on the augmented audio data.

7. The augmented audio output system as claimed in claim 6, wherein the plurality of audio output devices synchronizes the augmented audio data with the video and outputs the synchronized augmented audio data.

8. The augmented audio output system as claimed in claim 6, wherein the plurality of audio output devices provides their own information to the audio data server through the display device while operating in conjunction with the display device.

9. A method of outputting augmented audio, comprising:
a plurality of audio output devices receiving augmented audio data from an audio data server; and
the plurality of audio output devices augmenting audio of video, outputted from a display device operated in conjunction with the audio data server, by outputting different frequencies based on the augmented audio data.

10. The method as claimed in claim 9, further comprising the plurality of audio output devices synchronizing the augmented audio data with the video, before augmenting the audio of the video.

11. The method as claimed in claim 9, further comprising the plurality of audio output devices providing their own information to the audio data server through the display device, before receiving the augmented audio data.

12. A display device of a system for providing augmented audio service, the display device comprising:
an output unit for outputting video; and
a control unit for sending information about a plurality of audio output devices for augmenting audio of the video to an audio data server operated in conjunction with the plurality of audio output devices,
wherein the plurality of audio output devices receives augmented audio data from the audio data server and outputs the received augmented audio data as different frequencies based on the information.

13. The display device as claimed in claim 12, wherein the control unit receives the information from the plurality of audio output devices.

14. An augmented audio service method, comprising:
outputting video; and
sending information about a plurality of audio output devices for outputting augmented audio for augmenting audio of the video to an audio data server operated in conjunction with the plurality of audio output devices.

15. The augmented audio service method as claimed in claim 14, further comprising receiving the information from the plurality of audio output devices, before sending the information about the plurality of audio output devices.

16. The augmented audio service method as claimed in claim 14, further comprising checking whether the audio data server is capable of providing the augmented audio, after outputting the video.

17. The augmented audio service method as claimed in claim 14, wherein the plurality of audio output devices receives augmented audio data from the audio data server and outputs the received augmented audio data as different frequencies based on the information.
